(19) United States
(12) Patent Application Publication
(10) Pub. No.: US 2015/0199214 A1
(43) Pub. Date: Jul. 16, 2015

(54) SYSTEM FOR DISTRIBUTED PROCESSING OF STREAM DATA AND METHOD THEREOF

(71) Applicant: ELECTRONICS AND TELECOMMUNICATIONS RESEARCH INSTITUTE, Daejeon (KR)

(72) Inventors: Myung Cheol LEE, Daejeon (KR); Mi Young LEE, Daejeon (KR); Sung Jin HUR, Daejeon (KR)

(73) Assignee: ELECTRONICS AND TELECOMMUNICATIONS RESEARCH INSTITUTE, Daejeon (KR)

(21) Appl. No.: 14/249,768

(22) Filed: Apr. 10, 2014

(30) Foreign Application Priority Data
Jan. 13, 2014 (KR) 10-2014-0003728

(51) Int. Cl. G06F 9/48

(52) U.S. Cl. CPC G06F 9/4881

(57) ABSTRACT

Disclosed is a system for distributed processing of stream data, including: a service management device which selects an operation device optimal to perform an operation constituting a service and assigns the operation in a node including the selected operation device; and a task execution device which performs one or more tasks included in the operation through the selected operation device when the assigned operation is an operation registered in a preregistered performance acceleration operation library.

### CROSS-REFERENCE TO RELATED APPLICATIONS

This application claims priority to and the benefit of Korean Patent Application No. 10-2014-0003728 filed in the Korean Intellectual Property Office on Jan. 13, 2014, the entire contents of which are incorporated herein by reference.

### TECHNICAL FIELD

The present invention relates to a system for distributed processing of stream data and a method thereof, and particularly, to a system for distributed processing of stream data and a method thereof that perform a corresponding specific operation or a task included in the corresponding specific operation through an operation device and a node, which are optimal to perform the specific operation selected based on load information on the node and the operation device, among operation devices including a plurality of nodes and a plurality of heterogeneous performance accelerators.

### BACKGROUND ART

A system for distributed processing of stream data is a system that performs parallel distributed processing of large-capacity stream data.

With the advent of a big data age, a desire to analyze the big data by analyzing and processing the big data in real time has been increased. In particular, a need for a distributed stream processing system has been increased, which can process and analyze large-scale typical/atypical stream data in real time before storing the large-scale typical/atypical stream data in a permanent storage in real time by 3V (volume, variety, and velocity) attributes of the big data.

Applications for real-time processing and analyzing stream data which are continuously generated in quantity include real-time transportation traffic control, border patrol monitoring, a person positioning system, data stream mining, and the like in terms of typical data, and analysis of social data including Facebook, Twitter, and the like, and a smart video monitoring system through image/moving picture analysis in terms of the atypical data, and a lot of applications integrally analyze the typical data and the atypical data to intend to increase real-time analysis accuracy.

Products for distributed processing of typical and atypical stream data, such as IBM InfoSphere Streams, Twitter Storm, and Apache S4, make an effort for providing various functions as a general distributed stream processing system, such as processing support of the typical/atypical data, maximization of distributed stream processing performance, system stability, and development convenience, but in terms of performance, although changed depending on a unit size of stream data and complexity of processed operation, the products show a limitation of a stream data processing performance such as approximately 500,000 cases/sec. per node for each simple processing operation for simple tuple type typical data and 1,000,000 cases/sec. or less per maximum node.

When the typical stream data and the atypical stream data are separately described, in the case of the atypical data, since it is difficult to define the processing operation in advance and provide the processing operation, it is an important function to enable a user to easily define and use the operation, but in the case of the typical data, since a data model is defined in advance and an operation depending on the data model may also be defined in advance, when the distributed stream processing system implements and provides an optimal operation for each specific data model, a user may more easily process large-scale stream data by using the distributed stream processing system.

As such, in order to overcome a per-sec. stream processing performance limit of a single node of the existing products, the number of nodes is increased by allocating much more nodes to the distributed stream processing system to increase a total stream processing capacity at present, but this increases system building cost and processing and response time is delayed due to an increase in network transmission cost caused by communication between nodes.

Since the existing products performs stream data processing by only a central processing unit (CPU) installed in the system, a real-time stream data processing limit occurs.

### CITATION LIST

### Patent Document

Korean Patent No. 10-1245994

### SUMMARY OF THE INVENTION

The present invention has been made in an effort to provide a system for distributed processing of stream data and a method thereof that perform a corresponding specific operation or a task included in the corresponding specific operation through an operation device and a node, which are optimal to perform the specific operation selected based on load information on the node and the operation device, among operation devices including a plurality of nodes and a plurality of heterogeneous performance accelerators.

The present invention has also been made in an effort to provide a system for distributed processing of stream data and a method thereof that determine a performance accelerator, which can perform the operation optimally for each operation for each typical data model for the large-scale typical stream data, to implement the performance accelerator as a performance acceleration operation library and allocate corresponding typical stream data to a stream processing task for each performance accelerator installed in each node, which may optimally perform a processing operation of the corresponding typical stream data, and process the corresponding typical stream data.

An exemplary embodiment of the present invention provides a system for distributed processing of stream data, including: a service management device which selects an operation device optimal to perform an operation constituting a service and assigns the operation in a node including the selected operation device; and a task execution device which performs one or more tasks included in the operation through the selected operation device when the assigned operation is an operation registered in a preregistered performance acceleration operation library.

The operation device may include: a basic operation device including a central processing unit (CPU); and a performance accelerator including at least one of a field programmable gate array (FPGA), a general purpose graphics processing unit (GPGPU), and a many integrated core (MIC).

The CPU as a main processor may control a preprocessor or a coprocessor, and perform an operation having atypical data and a predetermined structure, the FPGA as a preprocessor may perform inputting, filtering, and mapping operation of typical data having a predetermined scale or more, the GPGPU as a coprocessor may perform an operation of typical data having a predetermined scale or more, and the MIC as a coprocessor may perform an operation of atypical data or typical data having a predetermined scale or more.

The service management device may include: a service manager which performs processing of any one of registration, deletion, and retrieval of a service by a user request; a resource monitoring unit which collects load information regarding a node and load information regarding an operation device at a predetermined time interval or as a response to the request, and constructs task reassignment information of the service based on the collected load information regarding the node and the operation device; and a scheduler which distributes and assigns one or more tasks included in the operation in a plurality of nodes based on the collected load information regarding the node and the operation device.

The load information regarding the node may include resource use state information for each node, types and the number of installed performance accelerators, and resource use state information of each performance accelerator, and the load information regarding the operation device may include an input load amount, an output load amount, and data processing performance information for each task.

The resource monitoring unit may determine whether to reschedule the service or a task included in the service based on the load information regarding the node and the operation device.

The scheduler may perform scheduling the task included in the service when receiving a task assignment request depending on the registration of the service from the service manager or a rescheduling request of the service or task from the resource monitoring unit.

The scheduler may select an implementation version for an operation device having the highest priority, which is optimal to perform the operation constituting the service, among implementation versions for a plurality of operation devices implemented for each operation, select a node installed with the selected operation device having the highest priority, and assign the operation constituting the service in the selected node when the selected node is usable.

The task execution device may include: a task executor which performs one or more tasks included in the operation assigned from the service management device; and a library unit which manages the performance acceleration operation library and a user registration operation library.

When the operation constituting the service corresponds to a performance acceleration operation preregistered in the library unit, the task executor may load the performance acceleration operation corresponding to the operation constituting the service preregistered in the library unit, and perform one or more tasks included in the operation based on the loaded performance acceleration operation.

When the operation constituting the service corresponds to a user registration operation preregistered in the library unit, the task executor may load the user registration operation corresponding to the operation constituting the service preregistered in the library unit, and perform one or more tasks included in the operation based on the loaded user registration operation.

Another exemplary embodiment of the present invention provides a method for distributed processing of stream data of a system for distributed processing of stream data, which includes a service management device and a task execution device, the method including: verifying, by the service management device, a flow of an operation constituting a service by analyzing a requested service; verifying, by the service management device, whether the operation constituting the service is the preregistered performance acceleration operation or the user registration operation based on the verified flow of the operation; when the operation constituting the service is an operation registered in the preregistered performance acceleration operation library as the verification result, selecting, by the service management device, an operation device optimal to perform the operation among a plurality of operation devices based on load information regarding a node and an operation device; assigning, by the service management device, the operation in a node including the selected operation device; and performing, by the task execution device, one or more tasks included in the operation.

The method may further include, when the operation constituting the service is the preregistered user registration operation as the verification result, selecting, by the service management device, an operation device optimal to perform the operation among a plurality of nodes including a CPU.

The performing of one or more tasks included in the operation may include: when the operation constituting the service is an operation registered in the preregistered performance acceleration operation library, loading a performance acceleration operation corresponding to the operation preregistered in a library unit; when the operation constituting the service is the preregistered user registration operation, loading a user registration operation corresponding to the operation preregistered in the library unit; and performing one or more tasks included in the operation based on the loaded performance acceleration operation or user registration operation.

The plurality of operation devices may include: a basic operation device including a CPU; and a performance accelerator including at least one of an FPGA, a GPGPU, and an MIC.

The selecting of the operation device optimal to perform the operation may include: selecting, by the service management device, an implementation version for an operation device having the highest priority, which is optimal to perform the operation constituting the service, among implementation versions for a plurality of operation devices implemented for each operation; selecting a node installed with the selected operation device having the highest priority; verifying whether to perform a task corresponding to the operation constituting the service through the selected node; assigning the operation constituting the service in the selected node when the selected node is usable as the verification result; determining whether there is an implementation version for a next-priority operation device corresponding to a next priority of the implementation version for the operation device having the highest priority, which is optimal to perform the operation constituting the service, when the selected node is not usable or there is no node installed with the selected operation device as the verification result; ending a process due to a failure to assign the operation constituting the service when there is no implementation version for the next-priority operation device as the determination result; and reselecting the implementation version for the next-priority operation device as an optimal operation device implementation version, when there is the implementation version for the next-priority operation device as the determination result, and returning to the selecting of the node installed with the reselected operation device.

According to exemplary embodiments of the present invention, a system for distributed processing of stream data and a method thereof maximize real-time processing performance of a single node for large-scale typical stream data and reduce the number of nodes required for processing total stream data by performing corresponding specific operation and a task included in the corresponding specific operation through an operation device and a node, which are optimal to perform the specific operation selected based on load information on a node and an operation device, among operation devices including a plurality of nodes and a plurality of heterogeneous performance accelerators, thereby reducing communication cost between nodes and providing faster processing and response time.

According to exemplary embodiments of the present invention, a system for distributed processing of stream data and a method thereof determine a performance accelerator, which can perform the service optimally for each operation for each typical data model for the large-scale typical stream data, to implement the performance accelerator as a performance acceleration operation library; and allocate the corresponding typical stream data to a stream processing task for each performance accelerator installed in each node that may optimally perform a processing operation of the corresponding typical stream data, to process the corresponding typical stream data, thereby achieving real-time processing performance of 2,000,000 cases/sec. or more per node by overcoming approximately 1,000,000 cases/sec. per node, which is a limit of real-time processing and volume in using only a CPU, and extending a real-time processing capacity of large-scale stream data and minimizing a processing time delay even in a cluster configured by a smaller-scale node.

### BRIEF DESCRIPTION OF THE DRAWINGS

FIG. 1 is a configuration diagram of a system for distributed processing of stream data according to an exemplary embodiment of the present invention.

FIG. 2 is a diagram illustrating an example of a cluster according to an exemplary embodiment of the present invention.

FIG. 3 is a diagram of an example to which the system for distributed processing of stream data according to the exemplary embodiment of the present invention is applied.

FIG. 4 is a diagram illustrating a service for consecutive processing of distributed stream data according to an exemplary embodiment of the present invention.

FIG. 5 is a conceptual diagram of the system for distributed processing of stream data using a performance accelerator including a service management device and a task execution device according to the exemplary embodiment of the present invention.

FIG. 6 is a flowchart illustrating a method for distributed processing of stream data according to a first exemplary embodiment of the present invention.

FIG. 7 is a flowchart illustrating a method for selecting an optimal operation device and an optimal node according to a second exemplary embodiment of the present invention.

### DETAILED DESCRIPTION

It is noted that Technical terms used in the specification are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that cannot accurately express the spirit of the present invention, the technical term is substituted by a technical term which can correctly appreciated by those skilled in the art to be appreciated. In addition, a general term used in the present invention should be analyzed as defined in a dictionary or according to front and back contexts and should not be analyzed as an excessively reduced meaning.

If singular expression used in the present invention is not apparently different on a context, the singular expression includes a plural expression. Further, in the present invention, it should not analyzed that a term such as “comprising” or “including” particularly includes various components or various steps disclosed in the specification and some component or some steps among them may not included or additional components or steps may be further included.

Terms including ordinal numbers, such as ‘first’, ‘second’, etc. in used in the present invention can be used to describe various components, but the components should not be limited by the terms. The above terminologies are used only for distinguishing one component from the other component. For example, a first component may be named as a second component and similarly, the second component may also be named as the first component.

Hereinafter, exemplary embodiments of the present invention will be described in detail with reference to the accompanying drawings, in which like or similar reference numerals refer to like elements regardless of reference numerals and a duplicated description thereof will be omitted.

In describing the present invention, when it is determined that the detailed description of the known art related to the present invention may obscure the gist of the present invention, the detailed description thereof will be omitted. Further, it is noted that the accompanying drawings are used just for easily appreciating the spirit of the present invention and it should not be analyzed that the spirit of the present invention is limited by the accompanying drawings.

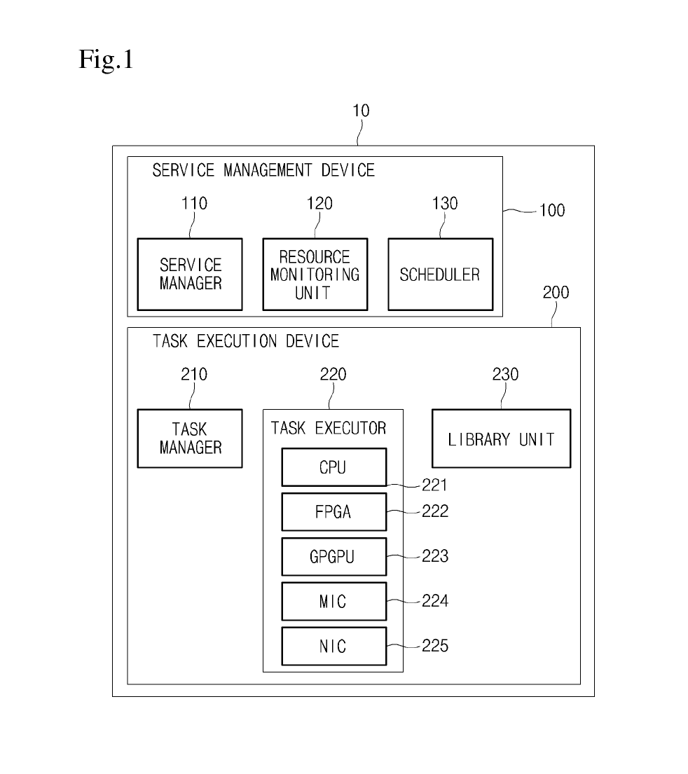

FIG. 1 is a configuration diagram of a system 10 for distributed processing of stream data according to an exemplary embodiment of the present invention.

As illustrated in FIG. 1, the system (alternatively, node) 10 for distributed processing of stream data includes a service management device 100 and a task execution device 200. All constituent elements of the system 10 for distributed processing of stream data, which is illustrated in FIG. 1, are not required, and the system 10 for distributed processing of stream data may be implemented by more constituent elements than the constituent elements illustrated in FIG. 1 or may also be implemented by fewer constituent elements than the constituent elements illustrated in FIG. 1.

The service management device 100 verifies whether an operation configuring a requested service is an operation registered in one or more preregistered performance acceleration operation libraries or a user registration operation, and when the operation configuring the corresponding service is an operation preregistered in the performance acceleration operation library according to the verification result, selects an operation device which is optimal to perform the corresponding operation based on load information on a node and an operation device, and thereafter, performs one or more tasks included in the corresponding operation through the selected operation device.

Respective nodes corresponding to the system 10 for distributed processing of stream data have constitutes of different operation devices for each node. Herein, the operation device includes one or more performance accelerators such as a field programmable gate array (FPGA), a general purpose graphics processing unit (GPGPU), and a many integrated core (MIC), and a central processing unit (CPU) which is a basic operation processing device. In this case, the respective operation devices include a network interface card (NIC) (alternatively, an NIC card) that connects different operation devices to each other. Herein, the performance accelerator means one or more simple execution units that may support operations which are relatively less than the CPU, which is the central processing unit, and efficiently perform the corresponding operations. Further, when the corresponding performance accelerator is used together with the CPU (a complex instruction set computer (CISC) or a reduced instruction set computer (RISC)) which supports a lot of operations, the performance of the system may be maximized as compared with a case in which only the CPU is used.

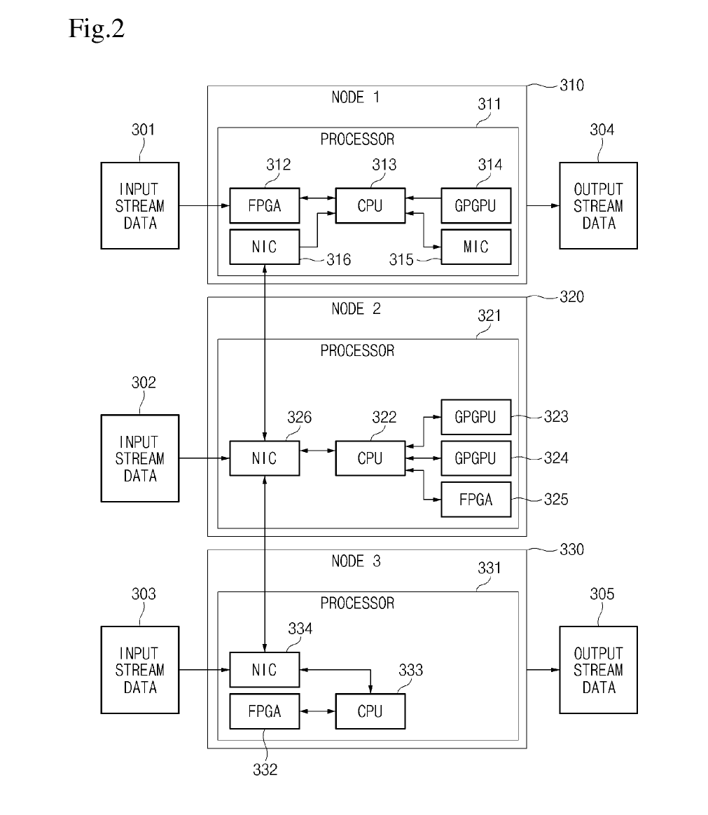

That is, as illustrated in FIG. 2, respective nodes 310, 320, and 330 include operation devices (alternatively, processors) 311, 321, and 332, respectively, for a cluster (alternatively, a distributed cluster) constituted by node 1 310, node 2 320, and node 3 330. In this case, the operation devices provided in the respective nodes may be the same as or different from each other. Herein, the node 1 310 includes the operation device 311 including one FPGA 312, one CPU 313, one GPGPU 314, and one MIC 315, and one NIC 316. Herein, the node 2 320 includes the operation device 321 including one CPU 322, two GPGPUs 323 and 324, and one FPGA 325, and one NIC 326. Further, the node 3 330 may include the operation device 331 including one FPGA 332 and one CPU 333, and one NIC 334. The respective nodes 310, 320, and 330 receive respective input stream data 301, 302, and 303 and then perform a predetermined operation for the received input stream data 301, 302, and 303, and the node 1 310 and the node 3 330 output output stream data 304 and 305, which are operation performing results, respectively, and the node 2 320 transfers (transmits) the output stream data, which is the operation performing result, to another node (for example, the node 1 or the node 3) through the NIC 326.

As described above, the respective nodes include the NIC that connects the CPU, which is a basic operation processing device, and the node, and further include one or more performance accelerators (for example, the FPGA, the GPGPU, the MIC, and the like).

The stream data (alternatively, input stream data) 301 and 303, which are transferred from the outside or another node, are received through the FPGAs 312 and 332 used as preprocessors for high performance, and task execution (alternatively, processing) for the received stream data 301 and 303 is performed, and thereafter, the output stream data 304 and 305, which are task execution results, are output, respectively.

The FPGA receives the stream data 302 through the NIC 326 in a node (for example, the node 2 320) which is not used to receive the stream data transferred from the outside or another node, and distributes and processes the received stream data 302 by a control of the CPU, and thereafter, transfers the output stream data, which is the task execution result, to a subsequent operation (alternatively, a subsequent task) which is being performed by the same node or another node (for example, the node 1 or the node 3).

One or more performance accelerators included in each node receive and process the stream data (alternatively, the operation corresponding to the stream data/the task for the operation) through the CPU included in the corresponding node, and transfer an operation processing result to the CPU again and thereafter, transfers the transferred operation processing result to the subsequent operation through the NIC.

For example, the node 1 310 rapidly receives and processes the large-scale stream data 301 at a high speed through one FPGA 312 preprocessor, and transfers the received stream data 301 to the CPU 313 which is the basic operation device. Thereafter, the CPU 313 transfers the corresponding stream data 301 to an optimal operation device among the CPU 313, the GPGPU 314, and the MIC 315 according to a characteristic and a processing operation of the received stream data 301. Thereafter, the corresponding optimal operation device performs an operation (alternatively, processing) for the corresponding stream data 301 transferred from the CPU 313, and thereafter, transfers an operation performing result to the CPU 313. Thereafter, the CPU 313 provides the operation performing result to the subsequent operation, which is being performed in another node (for example, the node 2 320), through the NIC 316.

As illustrated in FIG. 1, the service management device 100 includes a service manager 110, a resource monitoring unit 120, and a scheduler 130. All constituent elements of the service management device 100 illustrated in FIG. 1 are not required, and the service management device 100 may be implemented by more constituent elements than the constituent elements illustrated in FIG. 1 or may also be implemented by fewer constituent elements than the constituent elements illustrated in FIG. 1.

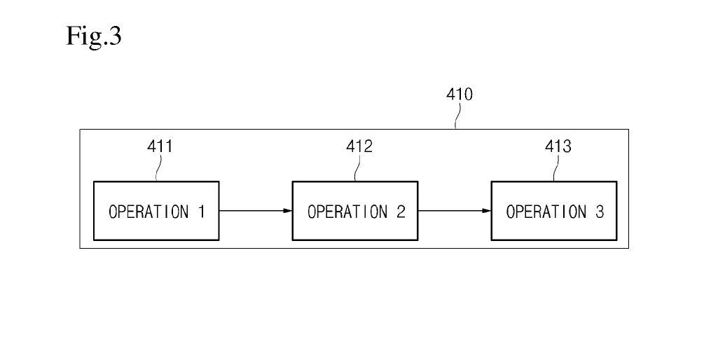

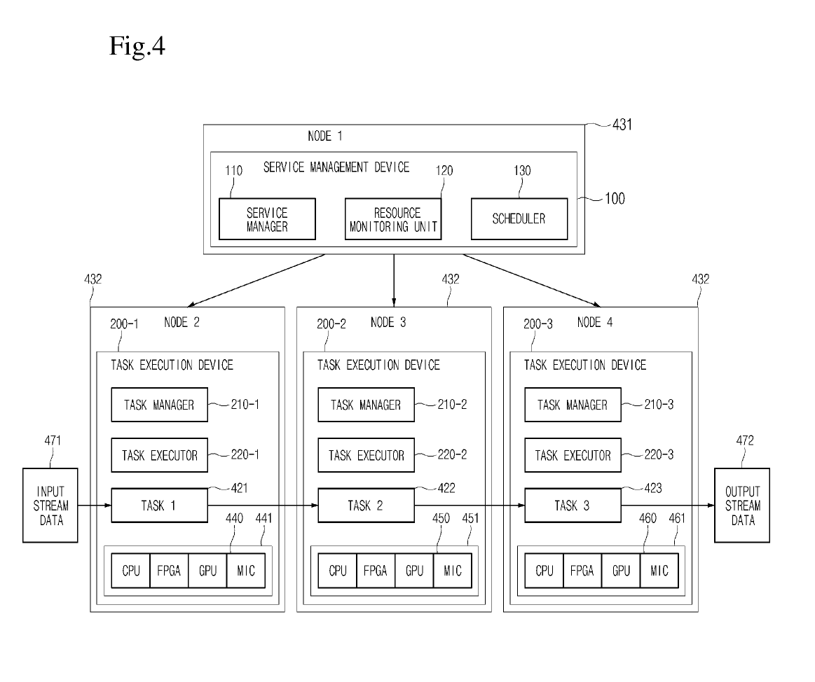

As illustrated in FIG. 3, the service manager 110 registers a plurality of (alternatively, one or more) operations (alternatively, a plurality of tasks included in the corresponding operations) constituting a service (alternatively, a distributed stream data consecutive processing service 410) illustrated in FIG. 4. In this case, as illustrated in FIG. 4, the service management device 100 may be positioned in a separate node (for example, the node 1) or together in a node (for example, the node 2, the node 3, and the node 4) where the task execution device 200 is positioned. Further, the service 410 is constituted by a plurality of operations 411, 412, and 413, and has an input/output flow of the stream data among the operations. Herein, the node (for example, the node 1) including the service management device 100 performs a master function, and the node (for example, the node 2, the node 3, and the node 4) including not the service management device 100 but only the task execution device 200 performs a slave function.

The service manager 110 performs processing such as registration, deletion, and retrieval of the service according to a user request.

Herein, the registration of the service means registering the plurality of operations 411, 412, and 413 constituting the service 410 illustrated in FIG. 4. Further, the operations 411, 412, and 413 in the corresponding service are executed by being divided into the plurality of tasks 421, 422, and 423. In this case, when registering the service, the system 10 for distributed processing of stream data may together register service quality information for each service or for each task (alternatively, for each operation) by an operation (alternatively, a control/a request) by an operator (alternatively, a user), and service quality may include processing rate of the stream data, and the like.

For example, the registration of the service may include distributing and allocating the plurality of tasks 421, 422, and 423 constituting the distributed stream data consecutive processing service 410 to a plurality of task executors 220-1, 220-2, and 220-3, and executing the tasks.

The deletion of the service means ending the execution of the related tasks 421, 422, and 423, which are being executed in the plurality of nodes, and deleting all related information.

The resource monitoring unit 120 collects an input load amount, an output load amount, and data processing performance information for each task at a predetermined time interval or as a response to a request through a task executor 220 included in the task execution device 200, collects information on a resource use state for each node, types and the number of installed performance accelerators, information on a resource use state of each performance accelerator, and the like, and constructs and analyzes task reassignment information of the service based on the collected information.

For example, the resource monitoring unit 120 collects the input load amount, the output load amount, and the data processing performance information for each of the tasks 421, 422, and 423, information on a resource use state/resource use state information for each node, the types and the number of the installed performance accelerators, and the resource use state information of each performance accelerator, at a predetermined cycle through the task execution devices 200-1, 200-2, and 200-3 illustrated in FIG. 3, thereby constructing the task reassignment information of the service.

As described above, the resource monitoring unit 120 collects load information regarding the node and load information regarding the operation device, and constructs the task reassignment information of the service based on the collected load information regarding the node and the operation device.

The resource monitoring unit 120 analyzes a service processing performance variation change with time to determine whether to reschedule the service or the task in the service.

The resource monitoring unit 120 requests the scheduler 130 to reschedule the determined service or the task in the service.

That is, the resource monitoring unit 120 transfers information regarding whether to reschedule the determined service or the task in the service to the scheduler 130 to reschedule the service or the task in the service through the corresponding scheduler 130.

When there is a request for rescheduling a specific task from the task executor 220 in the task execution device 200, the resource monitoring unit 120 transfers the request for rescheduling the corresponding specific task to the scheduler 130.

The resource monitoring unit 120 transfers the collected load information regarding the load and the operation device to the scheduler 130.

The scheduler 130 receives the load information regarding the node and the operation device transferred from the resource monitoring unit 120.

The scheduler 130 distributes and assigns the plurality of tasks to the plurality of nodes based on the received load information regarding the node and the operation device.

When receiving a task assignment request depending on the registration of the service from the service manager 110 or the request for rescheduling the service or the task from the resource monitoring unit 120, the scheduler 130 schedules (alternatively, assigns) the task.

When there is the task assignment request depending on the registration of the service from the service manager 110, the scheduler 130 selects a node having a spare resource based on resource information (alternatively, the load information regarding the node and the operation device) in a node managed by the resource monitoring unit 120, and assigns (alternatively, allocates) one or more tasks in (to) the task execution device 200 included in the selected node.

The scheduler 130 analyzes the service based on the execution of the requested service to verify (alternatively, determine) the flow of operation constituting the corresponding service.

The scheduler 130 performs an analysis process for each operation based on the verified flow of the operation.

The scheduler 130 verifies whether the operation constituting the service is an operation registered in one or more preregistered (alternatively, prestored) performance acceleration operation libraries or a user registration operation to a library unit 230 included in the task execution device 200.

As the verification result, when the operation constituting the service corresponds to the preregistered user registration operation, the scheduler 130 selects a node, which is optimal to perform the operation constituting the corresponding service, among the plurality of nodes including the CPU.

The scheduler 130 assigns the operation constituting the corresponding service in the selected node.

As the verification result, when the operation constituting the service corresponds to the operation registered in the preregistered performance acceleration operation library, the scheduler 130 selects an operation device (alternatively, an operation device, which is optimal to perform the operation constituting the corresponding service, and a node including the corresponding operation device) which is optimal to perform the operation constituting the corresponding service among the plurality of (alternatively, one or more) operation devices based on the load information regarding the node and the operation device provided by the resource monitoring unit 120 included in the service management device 100. Herein, the operation device includes one or more CPUs, FPGAs, GPGPUs, MICs, and the like.

The scheduler 130 selects an implementation version for an operation device (alternatively, an operation device having the highest priority) having the highest priority, which is optimal to perform the operation constituting the requested service, among implementation versions for a plurality of operation devices implemented for each operation. Herein, the priority may be granted to the implementation versions for each operation device of each operation according to a characteristic of the operation and a characteristic of the operation device.

For example, a map( ) operation may provide two implementation versions for operation devices (for example, a first priority is an FPGA version and a second priority is a CPU version) and a filter operation may provide three implementation versions for operation devices (for example, a first priority is the FPGA, a second priority is the GPGPU, and a third priority is the CPU).

As described above, all performance accelerators are not installed in the respective nodes constituting the distributed cluster. In each operation, operations of a plurality of versions are implemented for the basic operation device and the performance accelerator to be provided as the performance acceleration operation library.

The scheduler 130 selects a node (optimal node) installed with the selected operation device having the highest priority.

The scheduler 130 verifies whether the selected node is usable.

That is, the scheduler 130 verifies whether a task corresponding to the operation constituting the corresponding service may be performed (alternatively, processed) through the selected node.

As the verification result, when the selected node is usable, the scheduler 130 assigns the operation constituting the corresponding service in the selected node.

As the verification result, when the selected node is not usable or there is no node installed with the selected operation device, the scheduler 130 determines (verifies) whether there is an implementation version for a next-priority operation device corresponding to a next priority of the implementation version for the operation device having the highest priority, which is optimal to perform the operation constituting the corresponding service.

As the determination result, when there is no implementation version for the next-priority operation device corresponding to the next priority of the implementation version for the operation device having the highest priority, which is optimal to perform the operation constituting the corresponding service, the scheduler 130 fails to assign the operation constituting the corresponding service and reassigns the operation constituting the corresponding service by performing an initial process, and the like.

As the determination result, when there is the implementation version for the next-priority operation device corresponding to the next priority of the implementation version for the operation device having the highest priority, which is optimal to perform the operation constituting the corresponding service, the scheduler 130 reselects the implementation version for the next-priority operation device as the optimal operation device implementation version.

The scheduler 130 reperforms a step of selecting a node (alternatively, the optimal node) installed with the reselected optimal operation device.

The scheduler 130 assigns the operation constituting the corresponding service to the selected node (alternatively, the corresponding operation device included in the selected node).

As illustrated in FIG. 1, the task execution device 200 includes a task manager 210, the task executor 220, and the library unit 230. All constituent elements of the task execution device 200 illustrated in FIG. 1 are not required, and the task execution device 200 may be implemented by more constituent elements than the constituent elements illustrated in FIG. 1 or may also be implemented by fewer constituent elements than the constituent elements illustrated in FIG. 1.

The task manager 210 executes a thread of the task executor 220 executed in the process of the task execution device 200, and execution controls and manages the thread of the task executor 220.

The task executor 220 is allocated the task from the scheduler 130, may bind an input stream data source and an output stream data source for the allocated task, execute the task as a thread apart from the task execution device 200, and allow the task to be consecutively performed.

The task executor 220 performs control commands, such as allocation, stopping, resource increment, and the like of the task execution, for the corresponding task.

The task executor 220 periodically collects states of tasks, which are being executed, and a resource state of a performance accelerator installed in a local node.

The task executor 220 transfers the collected load information regarding the node and the operation device to the resource monitoring unit 120.

The task executor 220 performs one or more tasks included in the operation constituting the corresponding service assigned by the scheduler 130.

In this case, when the operation constituting the service corresponds to the preregistered user registration operation, the task executor 220 loads the user registration operation corresponding to the operation constituting the corresponding service preregistered in the library unit 230, and performs one or more tasks based on the loaded user registration operation.

In this case, when the operation constituting the service corresponds to the operation registered in the preregistered performance acceleration operation library, the task executor 220 loads the performance acceleration operation corresponding to the operation constituting the corresponding service preregistered in the library unit 230, and performs one or more tasks based on the loaded performance acceleration operation.

The accelerator library unit (alternatively, a storage unit/performance acceleration operation library unit) 230 stores a performance acceleration library corresponding to the operation (alternatively, the performance acceleration operation) optimally implemented in the performance accelerators including the CPU as the basic processing device, the FPGA, the GPGPU, the MIC, and the like, a user registration operation library (alternatively, a user defined operation library) corresponding to the user registration operation, and the like.

The library unit 230 may include at least one storage medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM).

As described above, the service 410 illustrated in FIG. 4 is divided into the plurality of task units 421, 422, and 423 by the service management device 100 and the task execution device 200, and distributed and allocated to multiple nodes 432, 433, and 434. Thereafter, the services are mapped to performance acceleration operations 441, 451, and 461 of library units 440, 450, and 460 to be executed, and consecutively distributes and parallelizes the stream data in link with input and output stream data sources 471 and 472. In this case, performances may not be accelerated through the performance accelerator with respect to all typical/atypical data models and all operations, and some operations among the typical stream data processing operations have characteristics capable of using high parallelism of the performance accelerator. As examples of the characteristics, “tuple is basically processed only once”, “data may be repeatedly processed by means of a window operator”, “tuples are basically independent from each other to fundamentally provide data parallelism”, and the like are representative characteristics of stream data that increase usability of the performance accelerator.

Accordingly, the library unit 230 may define the operation so as to use the performance accelerator for only a predetermined typical data model and the special operations 441, 451, and 461 determined in the corresponding data model, and accelerate the performance by scheduling and assigning the corresponding operation.

The library unit 230 implements and provides the operation by the CPU version, which is the basic processing device, with respect to a typical data operation and some atypical data operations, which may not use the performance accelerator, and most operations for the atypical data are performed through the user registration operation library.

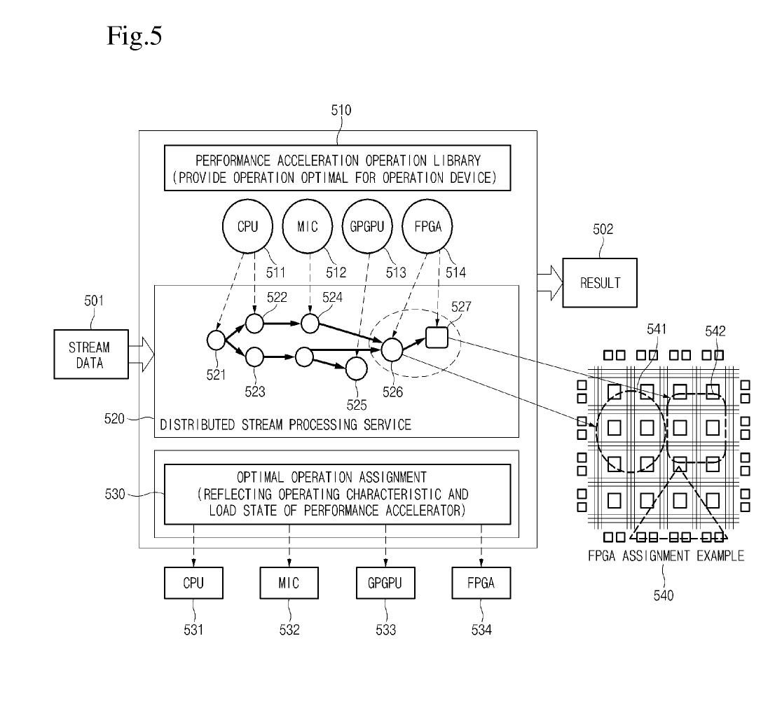

FIG. 5 is a conceptual diagram of the system 10 for distributed processing of stream data using the performance accelerator including the service management device 100 and the task execution device 200 according to the exemplary embodiment of the present invention.

Stream data 501 is distributed and parallelized based on a service (alternatively, a distributed stream data consecutive processing service) 520 expressed as a data flow based on a directed acyclic graph (DAG), and thereafter, a processing result 502 is output and provided to a user.

The service 520 is constituted by a plurality of operations 521 to 527, and each operation is implemented to be performed in a CPU 531 which is the basic operation device (511) or performed by selecting an actual implementation module from a performance acceleration operation library 510 which is constructed by being optimally implemented for each operation to be optimally performed for respective performance accelerators 532, 533, and 534 such as the MIC, the GPGPU, and the FPGA (512, 513, and 514).

For example, the operations 521, 522, and 523 are operations which are optimally performed in the CPU 531, and the operation 524 is an operation which is optimally operated in the MIC 532, the operation 525 is an operation which is optimally performed in the GPGPU 533, and the operations 526 and 527 are operations which are optimally performed in the FPGA 524.

The node in the distributed cluster includes a plurality of (alternatively, one or more) operation devices (alternatively, the basic processing device 531) and the performance accelerators 532, 533, and 534, for each node, and the respective operations 521 to 527 are assigned in the optimal node and operation device based on an operating characteristic of the operation device and the load information regarding the node and the operation device during scheduling the service 520.

Each of the operations 526 and 527, which are optimally performed in the FPGA illustrated in FIG. 5, does not exclusively use all FPGAs installed (alternatively, included) in each node, but the operations 526 and 527 divide and use logical blocks 541 and 542 of the FPGA (540).

[Table 1] described below summarizes advantages and disadvantages by respective unique hardware characteristics for each device with respect to an operation device (including, for example, the CPU which is the basic processing device, and the FPGA, the GPGPU, the MIC, and the like which are the performance accelerators) of a computing node.

TABLE 1

| Operation | | |
|---|---|---|
| device | Advantages | Disadvantages |
| CPU | Suitable for complicated logic and | Limitation in a single core, single |
| | control | thread performance according to |
| | | Moore's rule (within approximately |
| | | 3.x GHz) |
| | | Limitation in the number of cores |
| | | installable in a single node (within |
| | | approximately 10 cores) |
| | | High cost is generated as the number |
| | | of cores increases |
| FPGA | There is no delay in processing by | It is difficult to implement the |
| | processing a simple operation at a | operation by requiring a lot of |
| | hardware velocity due to constitution | understandings of the FPGA itself |
| | of hundreds of ALUs (operation | All complicated operations |
| | devices) | performed in CPU cannot be ported to |
| | Suitable for the preprocessor of CPU | FPGA |
| | because FPGA is optimal for simple | |
| | operations such as high-speed filter | |
| | and map operations of a large-scale | |
| | stream input from a network | |
| GPGPU | Optimal for data parallelism and | Requires communication between |
| | thread parallelism and suitable as the | CPU and GPU through a PCI-Express |
| | coprocessor of CPU | channel, which is relatively slow, in |
| | Suitable for high-speed parallel | using the coprocessor of CPU. |
| | execution of a computation-intensive | Therefore, in an application in which |
| | simple operation | data is frequently transferred between |
| | Shows more flops performance at | CPU and GPU, performance may still |
| | lower cost than CPU | deteriorate |
| | | More easily develops the operation |
| | | than FPGA, but requires |
| | | understanding GPGPU itself and |
| | | learning CUDA |
| | | All complicated operations |
| | | performed in CPU cannot be ported to |
| | | GPGPU |
| MIC | Optimal for high-speed parallel | Yet insufficient to release and verify |
| | execution of computation-intensive | a commercial product |
| | operation having complicated logic | The smaller number of cores than |
| | and suitable as the coprocessor of CPU | FPGA/GPGPU (approximately 50 |
| | More easily develops the operation | cores are limited in the case of |
| | than FPGA/GPGPU by sharing a | Knights Corner) |
| | programming environment having a | |
| | standard Intel structure such as Intel | |
| | CPU | |

As described above, the system 10 for distributed processing of stream data according to the present invention divides the type of the data model and the type of the operation, which may be optimally performed for each operation device, so as to well use the CPU, the FPGA, the GPGPU, and the MIC, which are installed in the plurality of nodes, according to an operation characteristic under a distributed stream processing environment, due to different performance characteristics of various operation devices (including, for example, the CPU which is the basic processing device, and the FPGA, the GPGPU, the MIC, and the like which are the performance accelerators).

[Table 2] described below classifies operations, which may be processed well for each operation device, by analyzing the advantages and disadvantages of [Table 1], and the classification is used as a criterion when developing the performance acceleration operation library and optimally assigning each operation, in the system 10 for distributed processing of stream data, which uses the performance accelerator of the present invention.

TABLE 2

| Operation | |
|---|---|
| device | Optimal operation |
| CPU | Main processor |
| | Operation having atypical data and complicated structure/flow |
| | Controlling preprocessor/coprocessor |
| FPGA | Preprocessor |
| | Inputting, filtering, and mapping of large-scale typical data |
| GPGPU | Coprocessor |
| | Performing simple operation of large-scale typical data |
| MIC | Coprocessor |
| | Complicated operation of atypical data and large-scale typical |
| | data |

As described above, a corresponding specific operation or a task included in the corresponding specific operation may be performed through an operation device and a node, which are optimal to perform the specific operation selected based on load information on the node and the operation device, among operation devices including a plurality of nodes and a plurality of heterogeneous performance accelerator.

As described above, a performance accelerator, which can perform the operation optimally for each operation for each typical data model, is determined for the large-scale typical stream data to implement the performance accelerator as a performance acceleration operation library, and corresponding typical stream data is allocated to a stream processing task for each performance accelerator installed in each node, which may optimally perform a processing operation of the corresponding typical stream data, to process the corresponding typical stream data.

Hereinafter, a method for distributed processing of stream data according to the present invention will be described in detail with reference to FIGS. 1 to 7.

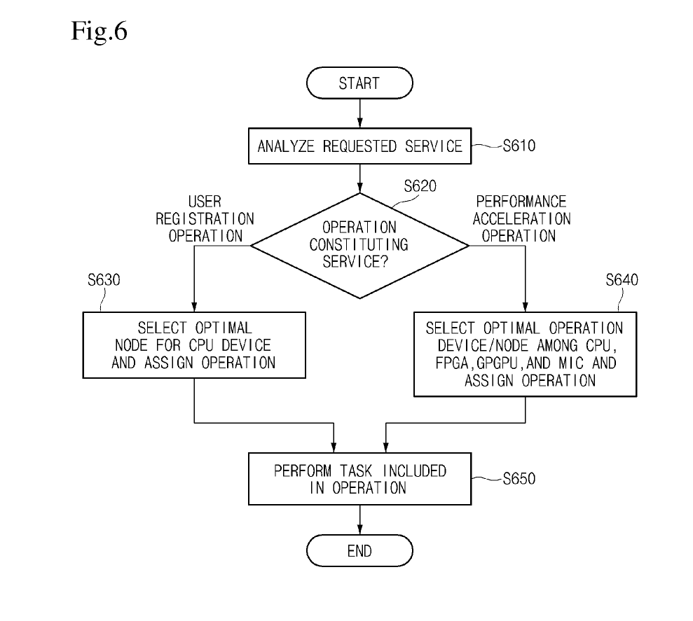

FIG. 6 is a flowchart illustrating a method for distributed processing of stream data according to a first exemplary embodiment of the present invention.

First, the scheduler 130 included in the service management device 100 analyzes the service based on the execution of the requested service to verify (alternatively, determine) the flow of operation constituting the corresponding service (S610).

Thereafter, the scheduler 130 performs an analysis process for each operation based on the verified flow of the operation.

That is, the scheduler 130 verifies whether the operation constituting the service is an operation registered in one or more performance acceleration operation libraries preregistered (alternatively, prestored) in the library unit 230 included in the task execution device 200 or a user registration operation (S620).

As the verification result, when the operation constituting the service corresponds to the preregistered user registration operation, the scheduler 130 selects a node, which is optimal to perform the operation constituting the corresponding service, among the plurality of nodes including the CPU.

The scheduler 130 assigns the operation constituting the corresponding service in the selected node (S630).

As the verification result, when the operation constituting the service corresponds to the operation registered in the preregistered performance acceleration operation library, the scheduler 130 selects an operation device (alternatively, an operation device, which is optimal to perform the operation constituting the corresponding service, and a node including the corresponding operation device), which is optimal to perform the operation constituting the corresponding service, among the plurality of (alternatively, one or more) operation devices, based on the load information regarding the node and the operation device provided by the resource monitoring unit 120 included in the service management device 100. Herein, the operation device includes one or more CPUs, FPGAs, GPGPUs, MICs, and the like. In this case, the scheduler 130 may select the operation device, which is optimal to perform the corresponding operation, based on the operating characteristic of the performance accelerator included in each node, in addition to the load information regarding the node and the operation device.

The scheduler 130 assigns the operation constituting the corresponding service to the selected node (alternatively, the corresponding operation device included in the selected node).

As one example, as the verification result, when the operation constituting the service is included in the operation registered in the preregistered performance acceleration operation library, the scheduler 130 selects a first node (alternatively, a first GPGPU, which is an operation device optimal to perform the operation constituting the corresponding service, and the first node including the corresponding first GPGPU), which is optimal to perform the operation constituting the corresponding service, among a plurality of nodes including one or more operation devices, based on the load information regarding the node and the operation device provided in the resource monitoring unit 120.

The scheduler 130 assigns the operation constituting the corresponding service in the selected first node (alternatively, the first GPGPU) (S640).

Thereafter, the task executor 220 included in the task execution device 200 performs one or more tasks included in the operation constituting the corresponding service assigned by the scheduler 130.

In this case, when the operation constituting the service corresponds to the preregistered user registration operation, the task executor 220 loads the user registration operation corresponding to the operation constituting the corresponding service preregistered in the library unit 230, and performs one or more tasks based on the loaded user registration operation.

When the operation constituting the service corresponds to the operation registered in the preregistered performance acceleration operation library, the task executor 220 loads the performance acceleration operation corresponding to the operation constituting the corresponding service preregistered in the library unit 230, and performs one or more tasks based on the loaded performance acceleration operation (S650).

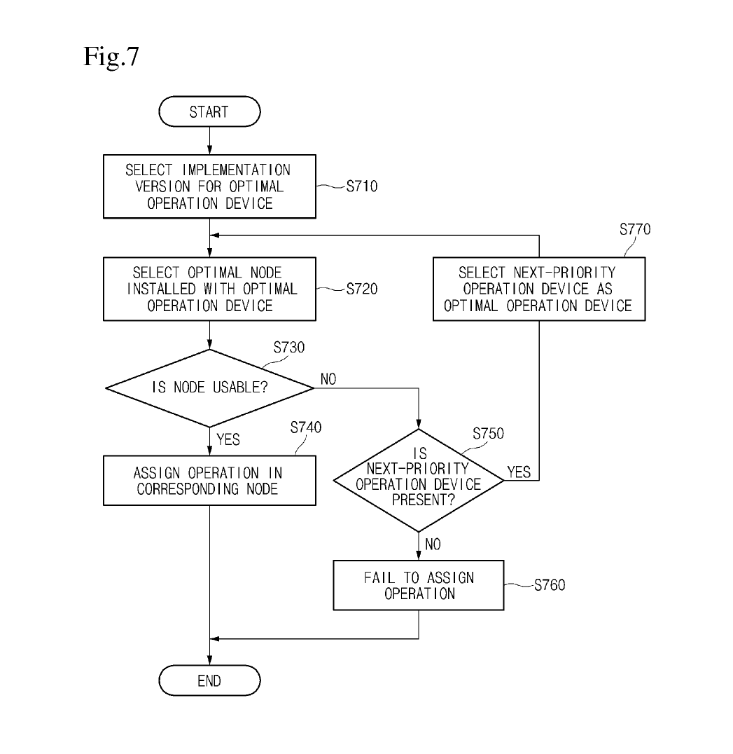

FIG. 7 is a flowchart illustrating a method for selecting an optimal operation device and an optimal node according to a second exemplary embodiment of the present invention.

First, the scheduler 130 selects an implementation version for an operation device (alternatively, an operation device having the highest priority) having the highest priority, which is optimal to perform the operation constituting the requested service, among implementation versions for a plurality of operation devices implemented for each operation.

As one example, the scheduler 130 selects a third FPGA having the highest priority, which is optimal to perform the map( ) operation constituting the requested service, among the implementation versions for the plurality of operation devices implemented for each operation. Herein, in the case of a priority of the implementation version for the operation device for the map( ) operation, a first priority may be the third FPGA, and a second priority may be a second CPU (S710).

Thereafter, the scheduler 130 selects a node (alternatively, an optimal node) installed with the selected operation device having the highest priority.

As one example, the scheduler 130 selects a third node installed with the third FPGA having the highest priority, which is optimal to perform the map( ) operation (S720).

Thereafter, the scheduler 130 verifies whether the selected node is usable.

That is, the scheduler 130 verifies whether a task corresponding to the operation constituting the corresponding service may be performed (alternatively, processed) through the selected node (S730).

As the verification result, when the selected node is usable, the scheduler 130 assigns the operation constituting the corresponding service to the selected node (S740).

As the verification result, when the selected node is not usable or there is no node installed with the selected operation device, the scheduler 130 determines (verifies) whether there is an implementation version for a next-priority operation device corresponding to a next priority of the implementation version for the operation device having the highest priority, which is optimal to perform the operation constituting the corresponding service.

As one example, as the verification result, when the third node installed with the third FPGA having the highest priority, which is optimal to perform the selected map( ) operation, is not usable, the scheduler 130 determines whether there is an implementation version for a next-priority operation device corresponding to a next priority of the third FPGA having the highest priority, which is optimal to perform the corresponding map( ) operation (S750).

As the determination result, when there is no implementation version for the next-priority operation device corresponding to the next priority of the implementation version for the operation device having the highest priority, which is optimal to perform the operation constituting the corresponding service, the scheduler 130 fails to assign the operation constituting the corresponding service and reassigns the operation constituting the corresponding service by performing an initial process, and the like.

As one example, as the determination result, when there is no implementation version for a next-priority operation device corresponding to a next priority of an FPGA having the highest priority, which is optimal to perform the map( ) operation, the scheduler 130 fails to assign the map( ) operation (S760).

As the determination result, when there is the implementation version for the next-priority operation device corresponding to the next priority of the implementation version for the operation device having the highest priority, which is optimal to perform the operation constituting the corresponding service, the scheduler 130 reselects the implementation version for the next-priority operation device as the optimal operation device implementation version.

The scheduler 130 performs a step (alternatively, step S720) of selecting a node (alternatively, the optimal node) installed with the reselected optimal operation device.

As one example, as the determination result, when there is the implementation version for the next-priority operation device corresponding to the next priority of the FPGA having the highest priority, which is optimal to perform the map( ) operation, the scheduler 130 reselects a second CPU which is the implementation version for the next-priority operation device as the optimal operation device implementation version. The scheduler 130 selects a second node installed with the reselected second CPU (S770).

As described above, according to exemplary embodiments of the present invention, it is possible to maximize real-time processing performance of a single node for large-scale typical stream data and reduce the number of nodes required for processing total stream data by performing a corresponding specific operation and a task included in the corresponding specific operation through an operation device and a node, which are optimal to perform the specific operation selected based on load information on a node and an operation device, among operation devices including a plurality of nodes and a plurality of heterogeneous performance accelerators, thereby reducing communication cost between nodes and providing faster processing and response time.

As described above, according to the exemplary embodiments of the present invention, it is possible to determine a performance accelerator, which can perform the operation optimally for each operation for each typical data model for the large-scale typical stream data, to implement the performance accelerator as a performance acceleration operation library, allocate corresponding typical stream data to a stream processing task for each performance accelerator installed in each node, which may optimally perform a processing operation of the corresponding typical stream data, to process the corresponding typical stream data, thereby achieving real-time processing performance of 2,000,000 cases/sec. or more per node by overcoming approximately 1,000,000 cases/sec. per node, which is a limit of real-time processing and volume in using only a CPU, and extending a real-time processing capacity of large-scale stream data and minimizing a processing time delay even in a cluster configured by a smaller-scale node.

Those skilled in the art can modify and change the above description within the scope without departing from an essential characteristic of the present invention. Accordingly, the various exemplary embodiments disclosed herein are not intended to limit the technical spirit but describe with the true scope and spirit being indicated by the following claims. The scope of the present invention may be interpreted by the appended claims and the technical spirit in the equivalent range is intended to be embraced by the invention.

What is claimed is:

1. A system for distributed processing of stream data, the system comprising:
a service management device which selects an operation device optimal to perform an operation constituting a service and assigns the operation in a node including the selected operation device; and
a task execution device which performs one or more tasks included in the operation through the selected operation device when the assigned operation is an operation registered in a preregistered performance acceleration operation library.

2. The system of claim 1, wherein the operation device includes:
a basic operation device including a central processing unit (CPU); and
a performance accelerator including at least one of a field programmable gate array (FPGA), a general purpose graphics processing unit (GPGPU), and a many integrated core (MIC).

3. The system of claim 2, wherein the CPU as a main processor controls a preprocessor or a coprocessor, and performs an operation having atypical data and a predetermined structure,
the FPGA as a preprocessor performs inputting, filtering, and mapping operation of typical data having a predetermined scale or more,
the GPGPU as a coprocessor performs an operation of typical data having a predetermined scale or more, and
the MIC as a coprocessor performs an operation of atypical data or typical data having a predetermined scale or more.

4. The system of claim 1, wherein the service management device includes:
a service manager which performs processing of any one of registration, deletion, and retrieval of a service by a user request;
a resource monitoring unit which collects load information regarding a node and load information regarding an operation device at a predetermined time interval or as a response to the request, and constructs task reassignment information of the service based on the collected load information regarding the node and the operation device; and
a scheduler which distributes and assigns one or more tasks included in the operation in a plurality of nodes based on the collected load information on the node and the operation device.

5. The system of claim 4, wherein the load information regarding the node includes resource use state information for each node, types and the number of installed performance accelerators, and resource use state information of each performance accelerator, and
the load information regarding the operation device includes an input load amount, an output load amount, and data processing performance information for each task.

6. The system of claim 4, wherein the resource monitoring unit determines whether to reschedule the service or a task included in the service based on the load information regarding the node and the operation device.

7. The system of claim 4, wherein the scheduler performs scheduling the task included in the service when receiving a task assignment request depending on the registration of the service from the service manager or a rescheduling request of the service or task from the resource monitoring unit.

8. The system of claim 4, wherein the scheduler selects an implementation version for an operation device having the highest priority, which is optimal to perform the operation constituting the service, among implementation versions for a plurality of operation devices implemented for each operation, selects a node installed with the selected operation device having the highest priority, and assigns the operation constituting the service in the selected node when the selected node is usable.

9. The system of claim 1, wherein the task execution device includes:
a task executor which performs one or more tasks included in the operation assigned from the service management device; and
a library unit which manages the performance acceleration operation library and a user registration operation library.

10. The system of claim 9, wherein when the operation constituting the service corresponds to a performance acceleration operation preregistered in the library unit, the task executor loads the performance acceleration operation corresponding to the operation constituting the service preregistered in the library unit, and performs one or more tasks included in the operation based on the loaded performance acceleration operation.

11. The system of claim 9, wherein when the operation constituting the service corresponds to a user registration operation preregistered in the library unit, the task executor loads the user registration operation corresponding to the operation constituting the service preregistered in the library unit, and performs one or more tasks included in the operation based on the loaded user registration operation.

12. A method for distributed processing of stream data in a system for distributed processing of stream data, which includes a service management device and a task execution device, the method comprising:
verifying, by the service management device, a flow of an operation constituting a service by analyzing a requested service;
verifying, by the service management device, whether the operation constituting the service is the predetermined performance acceleration operation or the user registration operation based on the verified flow of the operation;
when the operation constituting the service is an operation registered in the predetermined performance acceleration operation library as the verification result, selecting, by the service management device, an operation device optimal to perform the operation among a plurality of operation devices based on load information regarding a node and an operation device,
assigning, by the service management device, the operation in a node including the selected operation device; and
performing, by the task execution device, one or more tasks included in the operation.

13. The method of claim 12, further comprising:
when the operation constituting the service is the preregistered user registration operation as the verification result, selecting, by the service management device, an operation device optimal to perform the operation among a plurality of nodes including a CPU.

14. The method of claim 13, wherein the performing of one or more tasks included in the operation includes:
when the operation constituting the service is an operation registered in the preregistered performance acceleration operation library, loading a performance acceleration operation corresponding to the operation preregistered in a library unit;
when the operation constituting the service is the operation is the preregistered user registration operation, loading the user registration operation corresponding to the operation preregistered in the library unit; and
performing one or more tasks included in the operation based on the loaded performance acceleration operation or user registration operation.

15. The method of claim 12, wherein the plurality of operation devices includes:
a basic operation device including a CPU; and
a performance accelerator including at least one of an FPGA, a GPGPU, and an MIC.

16. The method of claim 12, wherein the selecting of the operation device optimal to perform the operation includes:
selecting, by the service management device, an implementation version for an operation device having the highest priority, which is optimal to perform the operation constituting the service, among implementation versions for a plurality of operation devices implemented for each operation;
selecting a node installed with the selected operation device having the highest priority;
verifying whether to perform a task corresponding to the operation constituting the service through the selected node;
assigning the operation constituting the service in the selected node when the selected node is usable as the verification result;
determining whether there is an implementation version for a next-priority operation device corresponding to a next priority of the implementation version for the operation device having the highest priority, which is optimal to perform the operation constituting the service, when the selected node is not usable or there is no node installed with the selected operation device as the verification result;
ending a process due to a failure to assign the operation constituting the service when there is no implementation version for the next-priority operation device as the determination result; and
reselecting the implement version for the next-priority operation device as an optimal operation device implementation version when there is the implementation version for the next-priority operation device as the determination result, and returning to the reselecting the node installed with the reselected operation device.
